(19) United States
(12) Patent Application Publication
(10) Pub. No.: US 2008/0042451 A1
(43) Pub. Date: Feb. 21, 2008

(54) Deadbolt handle locking device

(76) Inventors: Orel R. Moore, Myrtle Creek, OR (US); Melinda A. Moore, Myrtle Creek, OR (US)

Correspondence Address: LITMAN LAW OFFICES, LTD., P.O. BOX 15035, CRYSTAL CITY STATION, ARLINGTON, VA, 22215, US

(21) Appl. No.: 11/504,629

(22) Filed: Aug. 16, 2006

(51) Int. Cl. E05C 19/18

(52) U.S. Cl. 292/288

(57) ABSTRACT

The deadbolt handle locking device is releasable strap secured to a deadbolt lock handle of a door and to the shaft of a doorknob, selectively preventing rotation of the deadbolt lock handle. The securement device includes a base strap having a central portion and opposed proximal and distal ends. The proximal end of the base strap forms a loop having an adjustable circumference for adjustable and releasable tightening about the deadbolt lock handle. The central portion of the base strap is wound about the shaft of the doorknob, and a distal region of the central portion is releasably secured to a proximal region of the central portion, thus preventing rotation of the deadbolt lock handle and preventing unauthorized opening of the door. The distal region of the central portion may be secured to the proximal region by a hook-and-loop type fastener, for example.

### BACKGROUND OF THE INVENTION

1. Field of the Invention

The present invention relates to a deadbolt handle locking device, which is a releasable strap secured to a deadbolt lock handle of a door and to the shaft of a doorknob, selectively preventing rotation of the deadbolt lock handle.

2. Description of the Related Art

Exterior doors of homes, offices, and similar structures, as well as interior doors in hotel and apartment buildings and the like, are almost universally equipped with some form of locking means which generally immobilizes the rotating mechanism normally actuated by the doorknob to withdraw the tapered bolt from the striker plate. However, in many cases, such a lock system has been found to be insufficient, and an additional separate deadbolt lock has been added adjacent to the conventional locking doorknob latch assembly. Such deadbolts do not use tapered bolts, but rather are squared off, in order to be impossible to open by insertion of a card between the edge of the door and the jamb, and working the tapered bolt back.

Such deadbolts are conventionally provided with a keyhole or the like on the exterior, so persons may access the conventional cylinder and pin type lock typically used in such deadbolt mechanisms. However, such deadbolt mechanisms are almost universally provided with a latch handle or similar means to lock and unlock the deadbolt from the interior of the structure, in order that persons within the structure can quickly evacuate the structure in an emergency, without having to locate a key for the deadbolt lock. Such deadbolts provide a significant increase in security, but nevertheless can still be opened by unauthorized persons, who may have a stolen key, or using an unauthorized master key, etc. The conventional cylinder and pin type lock mechanisms may also vulnerable to picking without a key by skilled persons.

If the room or building is vacant of personnel, then there is no way to deter the unauthorized entrance of such a person into the area by picking or otherwise opening the deadbolt lock from the outside. However, typically such deadbolt locks are thought to add sufficient additional security, that typically no significant additional protection is provided for persons within the room or structure which has been locked from the inside by the deadbolt. Thus, a person sleeping in the room, or located in an area of the structure which is far removed from the bolted door, may not be aware of another person seeking unauthorized entry to the room or structure.

Accordingly, a need arises for an easy and economical means of securing a deadbolt lock handle from the interior of the door, in order to preclude unauthorized entry by other persons. The deadbolt security means must be completely portable so as to be conveniently carried by the user for use on any suitable door and lock assembly to which it is adapted. Latches, bolts, chains and other permanent devices for providing enhanced security are neither portable, nor are they adaptable, or readily transferable, to multiple doors. The device must further provide a completely pick-proof means of assuring that the internal latch handle cannot move physically, thereby completely obviating any attempts to enter the area by picking the deadbolt lock or using a key in the lock.

None of the above inventions, taken either singly or in combination, is seen to describe the instant invention as claimed. Thus, a deadbolt handle locking device solving the aforementioned problems is desired.

### SUMMARY OF THE INVENTION

The deadbolt handle locking device is a releasable strap secured to a deadbolt lock handle of a door and to the shaft of a doorknob, selectively preventing rotation of the deadbolt lock handle. The securement device includes a base strap having a central portion and opposed proximal and distal ends. The proximal end of the base strap forms a loop having an adjustable circumference for adjustable and releasable tightening about the deadbolt lock handle. The central portion of the base strap has opposed upper and lower surfaces and, in use, the central portion of the base strap is wound about the shaft of the doorknob, with the upper surface being positioned adjacent and contiguous with the shaft of the doorknob.

A distal region of the central portion is releasably secured to a proximal region of the central portion, thus preventing rotation of the deadbolt lock handle and preventing unauthorized opening of the door. The distal region of the central portion may be secured to the proximal region by any suitable releasable fastener, such as a hook-and-loop type fastener, for example.

A buckle is mounted to the proximal end of the base strap, allowing the user to selectively adjust the circumference of the loop. The loop may include a free end and a fixed end, with the fixed end being joined to the central portion of the base strap. The buckle is secured to the free end of the loop, and the fixed end is slidably received by, and passes through, the buckle. Alternatively, the loop may include a pair of fixed ends, both joined to the central portion of the base strap. In this alternative embodiment, the buckle is slidably mounted on the pair of fixed ends, allowing for selective adjustment and tightening of the loop about the deadbolt lock handle.

Further, an inner surface of the loop may have a frictionally engaging layer formed thereon, for releasably frictionally engaging the deadbolt lock handle. The frictionally engaging layer may be formed from rubber or the like. Additionally, the lower surface of the central portion of the base strap may have user-selectable indicia imprinted thereon.

The present deadbolt security device secures between the shank or shaft of a doorknob near the deadbolt mechanism on the inside of the door, and completely prevents any movement of the deadbolt latch handle, which is positively connected to the deadbolt itself. It is significant to note that the present invention security device strap secures to the outer end of a deadbolt handle, thus changing the leverage point of the deadbolt handle from the center to an end of the handle; this provides maximum holding power with less force or pull being exerted by the user to place the security strap in the locking position. Even a key or picking instruments cannot provide sufficient torque or leverage to overcome the grip of the present security device when it is secured to the deadbolt latch handle.

These and other features of the present invention will become readily apparent upon further review of the following specification and drawings.

### BRIEF DESCRIPTION OF THE DRAWINGS

FIG. 1 is an environmental, perspective view of a deadbolt handle locking device according to the present invention.

FIG. 2 is a perspective view of the deadbolt handle locking device according to the present invention.

FIG. 3 is a lower plan view of the deadbolt handle locking device according to the present invention.

FIG. 4 is an upper plan view of the deadbolt handle locking device according to the present invention.

FIG. 5 is a partial perspective view of an alternative embodiment of the deadbolt handle locking device according to the present invention.

FIG. 6 is a lower plan view of the deadbolt handle locking device, as in FIG. 3, in an unlooped configuration.

FIG. 7A is a partial perspective view of the deadbolt handle locking device of FIG. 5 with the buckle in a first position.

FIG. 7B is a partial perspective view of the deadbolt handle locking device of FIG. 5 with the buckle in a second position.

FIG. 8 is an environmental, perspective view of an alternative embodiment of the deadbolt handle locking device according to the present invention.

Similar reference characters denote corresponding features consistently throughout the attached drawings.

### DETAILED DESCRIPTION OF THE PREFERRED EMBODIMENTS

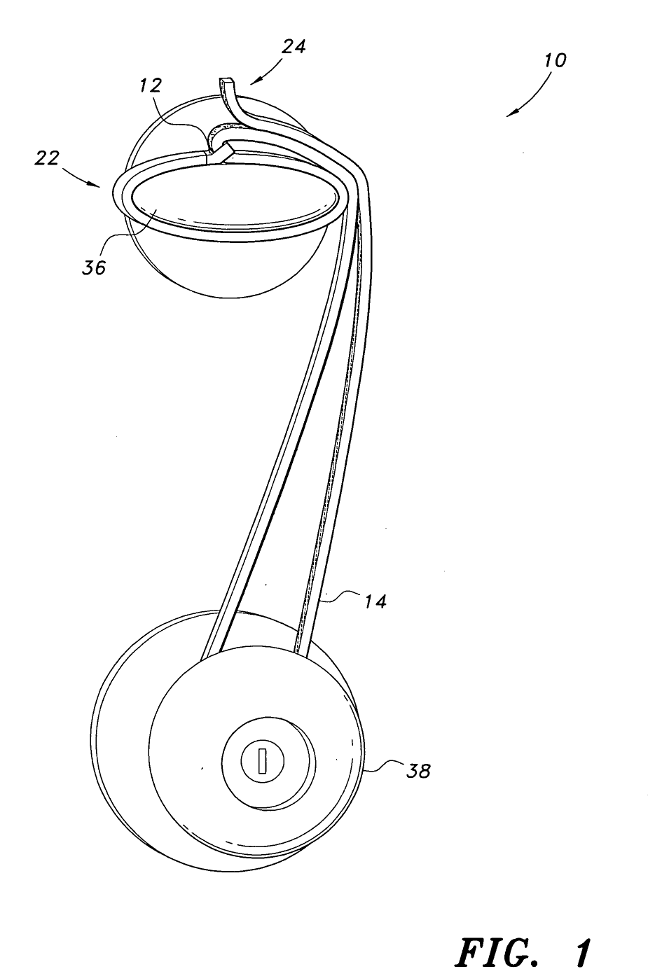

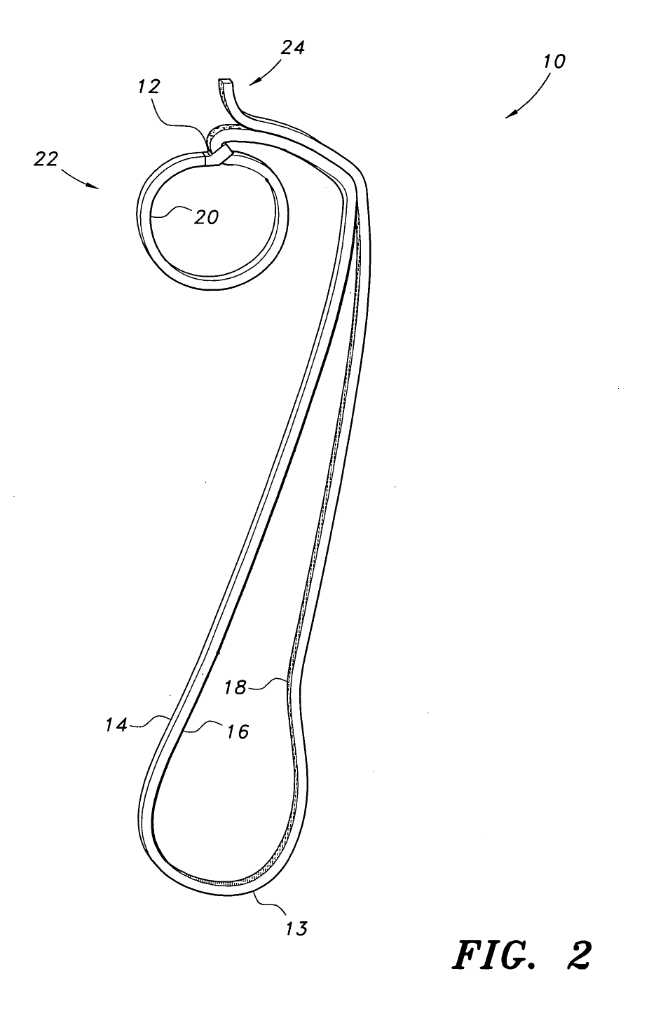

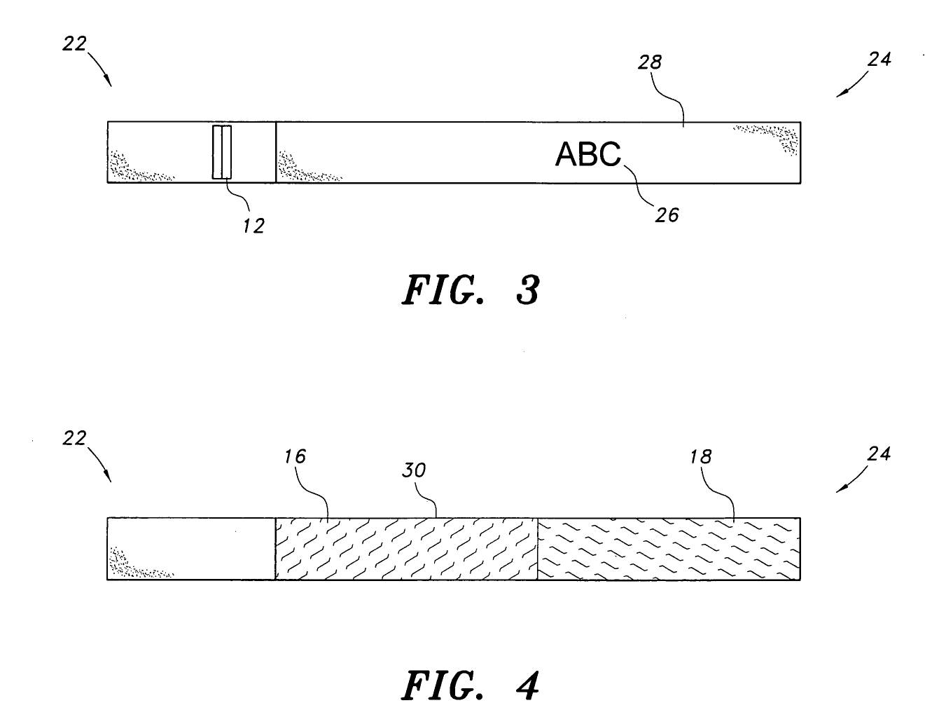

The present invention is directed towards a locking device 10 for deadbolt locks. As best shown in FIGS. 1 and 2, the locking device 10 is a releasable strap secured to a deadbolt lock handle 36 of a door, and to the shaft of a doorknob 38, selectively preventing rotation of the deadbolt lock handle 36. The locking device 10 includes a base strap 14 having a central portion 13 and opposed proximal and distal ends 22, 24, respectively. The base strap 14 may be formed from any suitable material, such as fabric, for example, which is structurally strong enough to prevent rotation of handle 36. As illustrated in FIGS. 3 and 4, in the preferred embodiment, base strap 14 has a substantially rectangular contour, however, it should be understood that base strap 14 may have any suitable contour, dependent upon the needs and desires of the user.

As best shown in FIGS. 1 and 2, the proximal end 22 of the base strap 14 forms a loop having an adjustable circumference for adjustable and releasable tightening about the deadbolt lock handle 36. In the embodiment illustrated in FIGS. 1 and 2, a buckle 12 is secured to the free end of proximal end 22 of base strap 14, forming the selectively adjustable loop. It should be understood that any suitable means for adjusting the circumference of the looped end may be utilized.

The central portion 13 of the base strap 14 has opposed upper and lower surfaces 30, 28, respectively, and, in use, the central portion 13 of the base strap 14 is wound about the shaft of the doorknob 38, with the upper surface 30 being positioned adjacent and contiguous with the shaft of the doorknob 38.

A distal region of the central portion 13 is releasably secured to a proximal region of the central portion 13, thus preventing rotation of the deadbolt lock handle and preventing unauthorized opening of the door. The distal region of the central portion may be secured to the proximal region by any suitable releasable fastener, such as a hook-and-loop type fastener, for example. In FIG. 4, a first fastening portion 18, such as hooks, for example, is shown secured to the distal region of central portion 13, and a second fastening portion 16, such as loops, for example, is shown secured to the proximal region of central portion 13. It should be understood that the hook-and-loop type fastener 16, 18 is shown for exemplary purposes only and that any suitable releasable fastener may be utilized, dependent upon the needs and desires of the user.

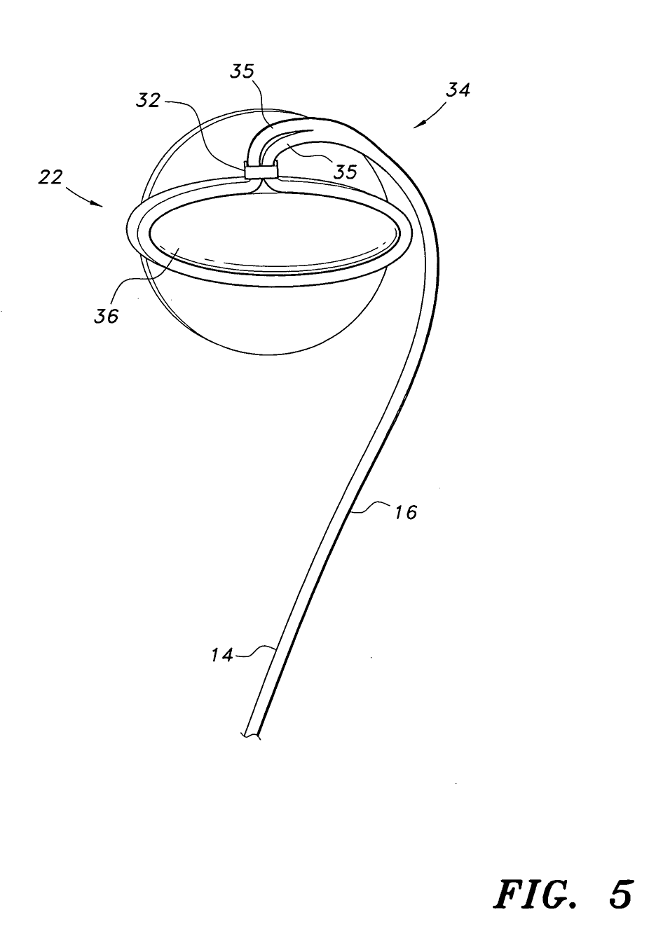

As noted above, in the embodiment of FIGS. 1 and 2, buckle 12 is mounted to the proximal end of the base strap 14, allowing the user to selectively adjust the circumference of the loop. The loop, in this embodiment, includes a free end and a fixed end, with the fixed end being joined to the central portion 13 of the base strap 14. The buckle 12 is secured to the free end of the loop, and the fixed end is slidably received by, and passes through, the buckle 12. Alternatively, as illustrated in FIG. 5, the loop may include a pair of fixed ends 35, both joined to the central portion 13 of the base strap 14, and forming a forked region 34. In this alternative embodiment, the buckle 32 is slidably mounted on the pair of fixed ends 35, allowing for selective adjustment and tightening of the loop about the deadbolt lock handle 36.

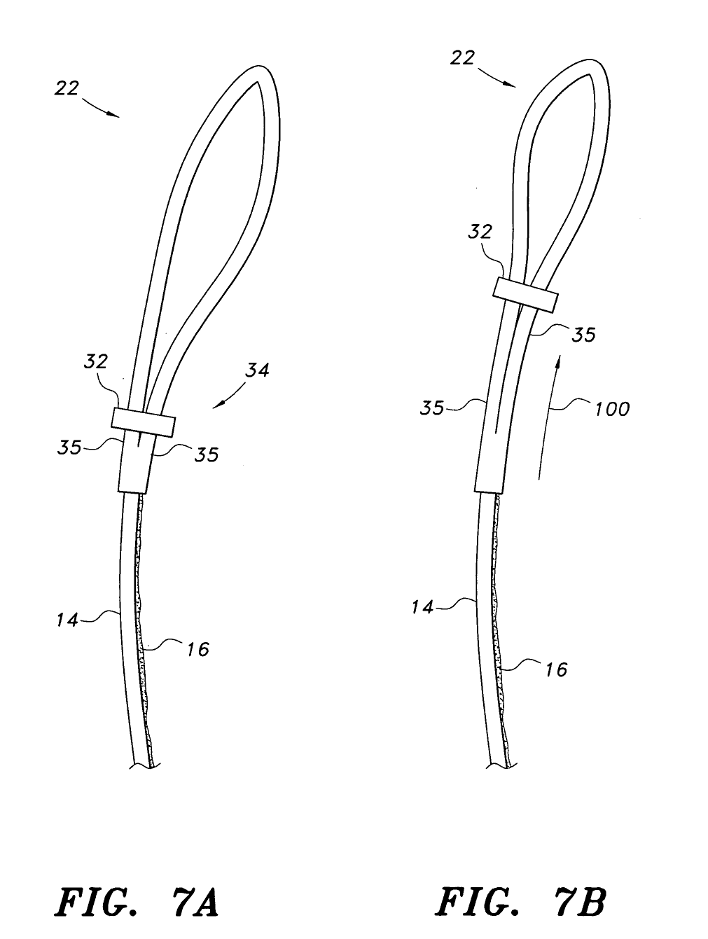

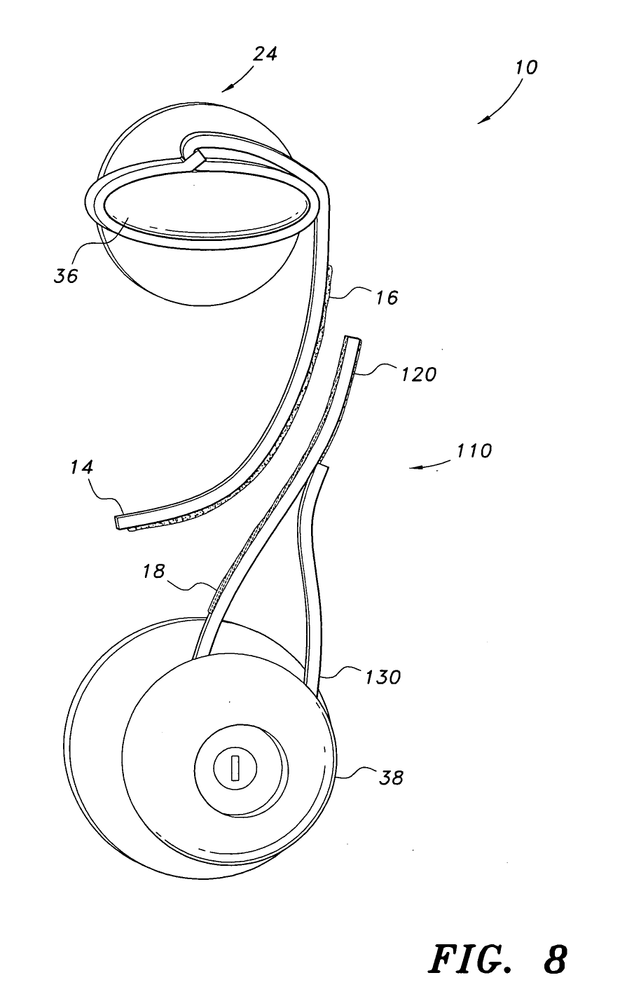

FIG. 7A illustrates the embodiment of FIG. 5 with the buckle 32 in a first, lower position, providing the user with a relatively wide-circumference looped portion 22, to be mounted on the deadbolt handle 36. In FIG. 7B, the buckle 32 is shown in a second, higher position (illustrated by directional arrow 100), allowing the looped portion 22 to be tightened about the deadbolt handle 36.

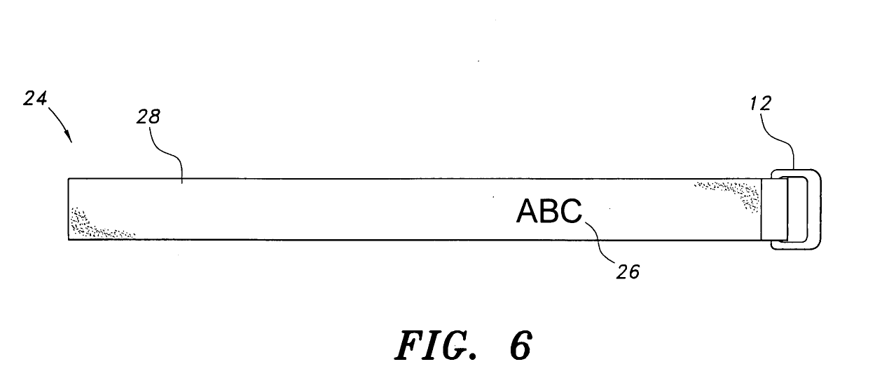

Further, an inner surface of the loop may have a frictionally engaging layer 20 formed thereon, for releasably frictionally engaging the deadbolt lock handle 36. The frictionally engaging layer 20 may be formed from rubber or the like. Additionally, as illustrated in FIG. 3, the lower surface 28 of the central portion 13 of the base strap 14 may have user-selectable indicia 26 imprinted thereon. It should be noted that in FIG. 3, end 22 is shown as being formed as an adjustable loop. FIG. 6 illustrates, in plan view, device 10 prior to the formation of looped end 22; i.e., buckle 12 has not yet received portion 14 in this configuration.

In FIG. 8, an extender strap 110 is provided, allowing for securement of a deadbolt handle 36 on a door which has a relatively large displacement between deadbolt lock handle 36 and doorknob 38. On a conventional door, the distance between the deadbolt handle 36 and the doorknob 38 is approximately 7 inches. However, a customized door may have a distance longer than the conventional 7 inches. Although device 10 may be produced in a wide variety of sizes, dependent upon the needs and desires of the user, the user may further employ extender strap 10, to be used in combination with device 10 for the securement of the deadbolt handle 36.

Extender strap 110 includes an upper portion 120 and a lower looped portion 130, as shown. Lower looped portion 130 is secured about the shaft of the doorknob 38, as shown, and the upper portion 120 has a fastening material 18 (such as that described above with reference to FIGS. 1-7B) formed thereon for releasable and adjustable securement with fastening material 16, of device 10. Thus, the user may adjustably and releasably secure the extender strap to the lower portion of device 10, allowing for securement of the deadbolt handle 36 in a manner similar to that described above.

The lower looped portion 130 is illustrated as having a permanent looped contour, preferably formed through sewing or similar methods. However, the looped portion 130 may be releasable and adjustable, through the use of releasable and adjustable fixtures, such as snaps, hook-and-loop type fasteners or the like. Further, it should be understood that looped portion 130 may be unsecured and the extender portion 110 may be used to lock the deadbolt handle 36 in place in a manner similar to that described above with regard to FIG. 1.

The present locking device 10 secures between the shank or shaft of doorknob 38, positioned near the deadbolt mechanism on the inside of the door, and the deadbolt lock handle 36, thus completely preventing any movement of the deadbolt latch handle 36. It is significant to note that the present invention secures to the outer end of deadbolt handle 36, thus changing the leverage point of the deadbolt handle 36 from the center to an end of the handle; this provides maximum holding power with less force or pull being exerted by the user to place the security strap 10 in the locking position. Even a key or picking instruments cannot provide sufficient torque or leverage to overcome the grip of the present security device 10 when it is secured to the deadbolt latch handle.

The locking device 10 allows for the looped portion 22 to secure about the perimeter of the deadbolt handle 36 itself, rather than the associated shaft, which would be rather cumbersome for the user, and difficult to secure. Further, as illustrated, the looped portion 22 secures the deadbolt handle 36 about its center, requiring only approximately one quarter of the strap to be wrapped about the deadbolt handle 36, rather than the entire strap. Thus, the device 10 may be easily and quickly secured to the deadbolt handle 36 and to doorknob 38. During the process of wrapping and attachment to the deadbolt handle 36, the buckle 12, 32 is automatically tightened to secure the looped end 22 about the deadbolt handle 36, once again providing ease of use and efficient application.

Further, it should be noted that the looped end 22 may be adjustably secured about a deadbolt handle 36 having any suitable size or contour, rather than just the exemplary deadbolt handle 36 illustrated in the Figures.

It is to be understood that the present invention is not limited to the embodiments described above, but encompasses any and all embodiments within the scope of the following claims.

1. A deadbolt handle locking device, comprising:
a base strap having opposed proximal and distal ends, said base strap further having a central portion, the central portion having an upper surface and a lower surface, the proximal end of said base strap forming a loop having a selectively adjustable circumference;
a buckle mounted to said proximal end of said base strap, said buckle being adapted for selective adjustment of the circumference of the loop;
a releasable fixture secured to the upper surface of the central portion of said base strap, whereby the loop is adapted for releasable securement to a deadbolt lock handle of a door and, in use, is selectively tightened therearound, the central portion of the base strap being adapted to be wrapped around the shaft of a doorknob of the door such that the upper surface of the central portion is positioned adjacent and contiguous to the shaft, the releasable fixture releasably securing a distal region of the central portion of the base strap to a proximal region of the central portion of the base strap, such that the deadbolt lock handle is selectively prevented from rotating; and
a frictionally engaging layer formed on an inner surface of the loop, the frictionally engaging layer being adapted for releasable contact and engagement with the deadbolt lock handle, said frictionally engaging layer being formed of a material having a substantially high frictional coefficient with respect to the deadbolt lock handle, whereby the frictionally engaging layer prevents slippage of the loop on the deadbolt lock handle.

2. (canceled)

3. The deadbolt handle locking device as recited in claim 1, wherein the loop has a free end and a fixed end, the fixed end being joined to the central portion of said base strap, said buckle being secured to the free end, the fixed end of the loop being slidably received through said buckle.

4. (canceled)

5. The deadbolt handle locking device as recited in claim 1, wherein the releasable fixture comprises a first fixture portion and a second fixture portion, the first fixture portion being secured to the proximal region of the central portion of the base, strap, and the second fixture portion being secured to the distal region of the central portion of the base strap, the first fixture portion releasably engaging the second fixture portion.

6. The deadbolt handle locking device as recited in claim 5, wherein the releasable fixture is a hook-and-loop type fastener.

7. The deadbolt handle locking device as recited in claim 1, further comprising user-selectable indicia imprinted on the lower surface of the central portion of said base strap.

8. The deadbolt handle locking device as recited in claim 1, wherein said central portion of said base strap has a user-adjustable length.

9-11. (canceled)

12. The deadbolt handle locking device as recited in claim 1, wherein the frictionally engaging layer is formed from rubber.
